(19) United States
(12) Patent Application Publication
(10) Pub. No.: US 2008/0286469 A1
(43) Pub. Date: Nov. 20, 2008

(54) METHOD FOR THE MANUFACTURE OF STEEL WOOL AND STEEL SHOT PELLETS

(76) Inventors: Andreas Baumbach, Effelder (DE); Siegfried Baumbach, Effelder (DE)

Correspondence Address: MAYER & WILLIAMS PC, 251 NORTH AVENUE WEST, 2ND FLOOR, WESTFIELD, NJ, 07090, US

(21) Appl. No.: 12/111,027

(22) Filed: Apr. 28, 2008

(30) Foreign Application Priority Data
Apr. 27, 2007 (DE) 10 2007 020 485

(51) Int. Cl. B05D 3/00

(52) U.S. Cl. 427/292; 72/324

(57) ABSTRACT

The invention relates to a method for the manufacture of steel wool and steel shot pellets. To this end, steel wire with a substantially circular diameter is made available as initial material. A quadratic or polygonal wire profile is produced by paring off steel shavings from the steel wire with paring knives that remove steel shavings along the axial direction. The pared-off steel shavings are available as steel wool. Small steel wire sections are subsequently divided off from the produced wire profile, which sections are subsequently rounded off in order to impart a polygonal form to them and to make them available as polygonal steel shot pellets.

### FIELD OF THE INVENTION

The present invention relates to a method suitable for the combined manufacture of steel wool and steel shot pellets.

### BACKGROUND OF THE INVENTION

Steel shot pellets are used in hunting ammunition and in ammunition for sporting weapons. In order to manufacture shot ammunition, a rather large number of shot pellets is brought into a shot cartridge that also contains a propellant charge and an igniter. Usually, the individual shot pellets are filled into a shot carton in an unordered manner that slides through the barrel of the weapon when a shot is fired in order to avoid direct contact of the shot pellets with the inner wall of the barrel, so that the barrel is not damaged. The shot pellets of a shot charge should have, to the extent possible, the same size and a uniform weight in order to achieve a regular shot pattern.

DE 101 51 585 C1 teaches a method for the manufacture of polygonal steel shot pellets in which the steel shot pellets are manufactured from a cylindrical steel wire that receives a polygonal cross section before the dividing off of small steel wire sections by deformation, especially by several rolling steps. The polygonal steel shot pellets to be manufactured by the known method do have numerous advantages over earlier designs and manufacturing methods; however, expensive deformation steps are still necessary here that must be used on the initial material. Usually, cylindrical rolled steel wires with a diameter of more than 5 mm are used in the known methods that are shaped by drawing and rolling to a quadratic profile.

Basically, the same rolled steel wires are used as initial material in other technological work cycles, especially for the manufacture of steel wool. Steel wool is needed, e.g., as an additive in brake linings. The thin steel shavings that form such steel wool can be manufactured, e.g., by paring them off from a rolled steel wire. DE 199 01 441 C1 shows a machine for the manufacture of steel wool in which a steel wire is guided in several adjacent wire windings over deflection rollers during which chips are pared off from the wire with knife cutting edges. During this time, the knife cutting edge attacks the wire in a relatively uncontrolled manner so that steel shavings can be pared off only down to a given residual diameter of the wire in order to prevent a rupture of the wire. A large amount of waste steel wire obligatorily remains that cannot be further processed to steel chips.

It is known from practice that in order to manufacture steel wool, a cylindrical rolled wire is at first reduced in diameter by drawing it in order to increase the tensile strength of the steel wire in this manner. Given a reduction of diameter of, e.g., 5.5 mm to 3.2 mm, the tensile strength can be increased from approximately 300 Nm to ca. 800 Nm with this method. Subsequently, shavings are pared off from the steel wire, during which the paring knife attacks the wire only from one side. An increase of efficiency can be achieved by arranging several paring knives that successively pare shavings from three different sides from the previously drawn steel wire. A steel wire with a triangular cross section remains as waste in this instance that can not be used further.

DE 1 627 748 A describes a method and an apparatus for manufacturing steel wool from wire. Wire with a quadratic or rectangular profile is used as initial material for the manufacture of the steel wool. The steel wool is pared of from the quadratic or rectangular wire with a knife. After this machining procedure, a residual wire with a rectangular cross section remains that can be used after an annealing treatment as a binding wire. This publication cites wire stitches and meshes that can be manufactured from the residual wire after appropriate treatment as further possibilities of use. In order to make such a usage of the residual wire possible, it must have a sufficient cross section. Therefore, only relatively little steel wool can be obtained from the initial material.

DE 24 27 780 B2 also indicates a steel wire for manufacturing steel wool which wire should have a level cutting surface facing the cutting tools. This steel wire does make the reduction of the so-called residual segment loss possible but a steel wire remnant also remains here that does not have any logical use. This publication indicates the percentage of material loss for quadratic profiles caused by the non-machinable residual segment at 14.2% and for round wire at 9.6%.

### SUMMARY OF THE INVENTION

The present invention therefore has the problem of designing the use of rolled steel wire to be more efficient, in particular in order to reduce the amount of waste in the manufacture of steel wool.

This problem is solved by the method indicated in Claim 1. It is particularly significant for the invention that the manufacture of steel wool can be combined with the manufacture of steel shot pellets, which can reduce the amount of waste that normally remains in the manufacture of steel wool to almost zero. To this end a steel wire with a circular diameter serving as initial material is pared in a controlled manner from several sides in order to impart a square or polygonal profile to the steel wire. The pared-off steel shavings are available as steel wool. The remaining steel wire with a square or polygonal cross section immediately serves in a further production process as initial material for the manufacture of steel shot pellets. To this end, the generated wire profile is divided into small steel wire sections that are subsequently subjected to a rounding-off process until the steel wire sections have a polygonal form.

During the execution of the method in accordance with the invention, in order to manufacture the steel wool the energy-intensive drawing of the rolled wire in order to increase the tensile strength can be dispensed with at first. Since it is not necessary to pare the rolled wire down to the smallest possible cross section, a distinctly lesser tensile strength suffices for avoiding the tearing of the steel wire during the paring process. Moreover, the tractive forces on the wire can be reduced by an opposing arrangement of paring knives.

After the rolled steel wire has been pared on at least four sides, e.g., down to a remaining circumferential diameter of ca. 3 mm, polygonal steel shot can be very readily manufactured from this polygonal wire profile. The customarily necessary drawing and/or rolling of circular rolled steel wire is eliminated since the short steel wire sections can be directly cut off of the polygonal wire profile. The required rounding-off process is shortened since the tensile strength of the material was not increased by a previous drawing procedure. The hardness required for steel shot is sufficient in traditional steel wire, especially since a soft surface is usually desired. As a rule even the otherwise customary heat treatment step for reducing the surface hardness and be eliminated therewith, yet it can still be carried out in modified embodiments.

A preferred embodiment of the method of the invention is distinguished in that the steel shavings are pared off in several layers from the rolled steel wire. To this end several paring knives are arranged along the direction of travel of the steel wire. It is especially advantageous if each two opposite paring knives are combined to one paring step, and at least two paring steps are successively arranged with paring knives offset by 90° in the axial or longitudinal direction of the rolled steel wire. In this manner a start is made at first from two sides on the steel wire of the paring process whereas the other two sides are worked in the following paring step.

Preferably, steel wire sections with a length approximately equal to the circumferential diameter of the wire profile are separated off from the quadratic or polygonal wire profile. In as far as the wire profile has a quadratic cross-section by appropriately setting up the paring knives, steel wire cubes with a unified edge length are present after the dividing off of the steel wire sections. These cubes are subsequently subjected in a known manner to the rounding-off process in order to form a polygonal surface on the steel shot pellets. The steel shot pellets can be subsequently polished in the case of high quality requirements and coated with an anti-rust agent.

Other advantages, details and further developments result from the following description of a preferred work cycle of the method in accordance with the invention with reference made to the drawing.

### BRIEF DESCRIPTION OF THE DRAWING

FIG. 1 shows a work cycle plan of a method for the combined manufacture of steel wool and steel shot.

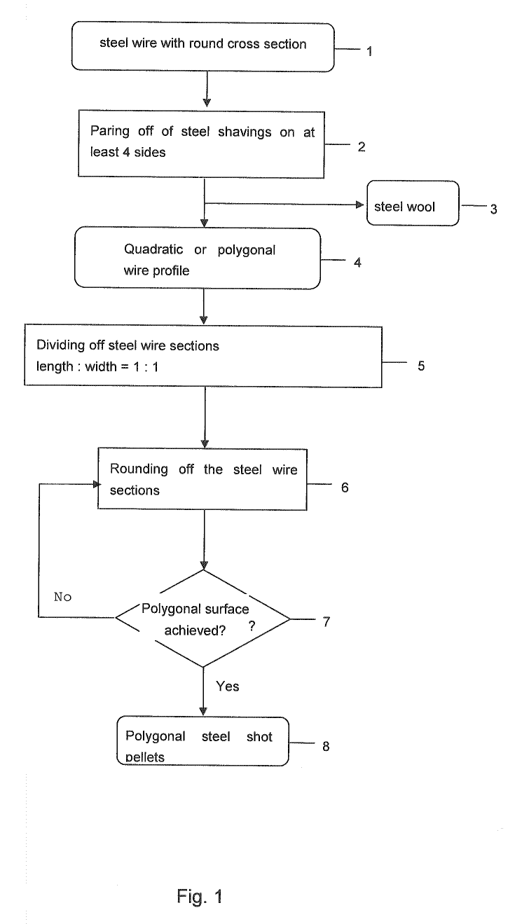

### DETAILED DESCRIPTION OF THE INVENTION

In step 1, traditional steel wire with a round section, e.g., with a diameter of 5.5 mm and a tensile strength of approximately 300 Nm is made available. In the following step 2, steel shavings are pared off from the circular steel wire on at least four sides. The paring off can take place in several layers by successively arranged paring knives. After the paring off of the steel shavings, the steel wool is available in step 3 as the first product of the method.

Since the paring off of the steel shavings is carried out only up to a given residual diameter or to a residual thickness, a quadratic or polygonal wire profile remains in step 4 that is preferably worked further without interrupting the method in a running process.

In the following step 5, small steel wire sections are separated from the polygonal wire profile, preferably in a length/width ratio of 1:1. To the extent the wire profile furnished in step 4 has a quadratic cross section, cube-shaped sections of steel wire are therefore present. The steel wire sections are subsequently supplied in a known manner to a rounding-off process. The rounding-off takes place in step 6, in particular with the aid of an acceleration apparatus that centrifuges the steel wire sections with a high speed onto baffle plates. The striking of the steel wire sections against the baffle plates deforms the edges of the steel wire sections in such a manner that that polygonal surface sections form. The steel wire sections run through the rounding-off process until the desired polygonal surface of the steel shot pellet is achieved. For example, a final form can be striven for in which the vertical distance between a spherical surface completely surrounding the steel shot pellet and between the polygonal surface is not more at any point than 20% of the diameter of this spherical surface. The rounding-off process is broken off if it is determined in step 7 that the given condition for the polygonal surface has been reached. In step 8 polygonal shot pellets are present as a second result of the method in accordance with the invention.

If needed, thermal treatment steps and surface enhancement steps can follow in order to adapt the steel shot pellets to the desired usages. Such surface treatment steps are known to a person skilled in the art so that a more detailed description will not be given here.

The described method is preferably carried out in a uniform manufacturing stretch so that no intermediate storage of the polygonal wire profile is necessary after the paring off of the steel shavings. Essentially no waste is produced, so that the utilization of the material can be considered as optimal. It is also advantageous that steel shot pellets are additionally produced that are available as a second marketable method product substantially in the same manufacturing time required in the state of the art for the production of steel wool.

1. A method for the manufacture of steel wool and steel shot pellets comprising the following steps:
making available a steel wire with a substantially circular diameter;
producing a rectangular or polygonal wire profile with a given circumferential diameter by paring off steel shavings from the steel wire with paring knives that remove steel shavings along the axial direction, which paring knives attack at least four sides of the steel wire;
making available the steel shavings as steel wool;
dividing off small steel wire sections from the produced wire profile;
rounding-off the steel wire sections until they have a polygonal form;
making available the rounded-off polygonal steel wire sections as steel shot pellets.

2. The method according to claim 1, wherein the paring off of the steel shavings takes place in several layers by several successively arranged paring knives.

3. The method according to claim 1, wherein a substantially quadratic wire profile is produced by paring off steel shavings with four paring knives.

4. The method according to claim 1, wherein during the paring off of the steel shavings, each two opposite paring knives are combined to one paring step, and wherein steel wire runs through at least two paring steps successively arranged in the axial direction.

5. The method according to claim 1, wherein the steel wire sections are divided off with a length approximately equal to the circumferential diameter of the wire profile from the quadratic or polygonal wire profile produced.

6. The method according to claim 1, wherein the rounded-off steel shot pellets can be subjected to a thermal treatment in order to reduce surface hardness.

7. The method according to claim 1, wherein the steel shot pellets are finally polished and coated with an anti-rust agent.

8. The method according to claim 1, wherein rolled steel wire with a diameter >4 mm, preferably 5.5 mm is used.

9. The method according to claim 1, wherein the circumferential diameter of the quadratic or polygonal wire profile is <3.5 mm, preferably 3.2 mm after the paring off of the steel shavings.
